(19) United States
(12) Patent Application Publication
(10) Pub. No.: US 2012/0262617 A1
(43) Pub. Date: Oct. 18, 2012

(54) WIRELESS IMAGE SHOOTING DEVICE

(75) Inventors: JASON CHENG, Taipei City (TW); LUTHER FAN, Taipei City (TW)

(73) Assignee: DIGILIFE TECHNOLOGIES CO., LTD., Taipei City (TW)

(21) Appl. No.: 13/337,639

(22) Filed: Dec. 27, 2011

(30) Foreign Application Priority Data
Apr. 12, 2011 (TW) 100206355

(51) Int. Cl. H04N 5/222

(52) U.S. Cl. 348/333.01; 348/E05.024

(57) ABSTRACT

A wireless image shooting device includes a main body and a controlling display module. The main body includes a first central processing unit (CPU), a first wireless transmission unit, a first memory unit and an image shooting unit. The controlling display module includes a second CPU, a second wireless transmission unit, a second memory unit and a touch display unit. When the controlling display module is connected to the main body, data is transmitted between the first and the second CPU via cables; and when the controlling display module is separated from the main body, data is wirelessly transmitted between the first and the second wireless transmission unit. With these arrangements, the main body can be wirelessly controlled by the controlling display module to shoot images, so that the wireless image shooting device has increased functionality.

### CROSS-REFERENCE TO RELATED APPLICATION

This non-provisional application claims priority under 35 U.S.C. §119(a) on Patent Application No(s). 100206355 filed in Taiwan, R.O.C. on Apr. 12, 2011, the entire contents of which are hereby incorporated by reference.

### FIELD OF THE INVENTION

The present invention relates to a wireless image shooting device, and more particularly to a wireless image shooting device that includes separable main body and controlling display module, and the main body can be wirelessly controlled by the controlling display module to shoot images, giving the wireless image shooting device increased functionality.

### BACKGROUND OF THE INVENTION

Due to the quick progress in various technical fields, most people now possess a portable image shooting device. The portable image shooting device generally includes a main body and a liquid crystal display (LCD). The LCD display is pivotally connected to the main body, and a user may watch the LCD display while shooting images. In the conventional portable image shooting device, the LCD display is inseparably connected to the main body. Since the LCD display could not be separated from the main body and be used to remotely control the main body for shooting images, it is impossible for a user to carry the LCD display alone to some other place while leaving the main body on site for shooting images under control of the LCD display. Therefore, the conventional portable image shooting device has low functionality.

It is therefore tried by the inventor to develop an improved wireless image shooting device that includes a controlling display module separable from a main body to wirelessly control the main body for shooting images, so that the wireless image shooting device has increased functionality.

### SUMMARY OF THE INVENTION

A primary object of the present invention is to provide a wireless image shooting device that includes separable main body and controlling display module, and the main body can be wirelessly controlled by the separated controlling display module to shoot images, giving the wireless image shooting device increased functionality.

To achieve the above and other objects, the wireless image shooting device according to the present invention includes a main body and a controlling display module removably connected to the main body. The main body includes a first central processing unit (CPU), a first wireless transmission unit, a first memory unit and an image shooting unit. The first wireless transmission unit, the first memory unit and the image shooting unit are electrically connected to the first CPU. The controlling display module includes a second CPU, a second wireless transmission unit, a second memory unit and a touch display unit. The second wireless transmission unit, the second memory unit and the touch display unit are electrically connected to the second CPU. When the controlling display module is connected to the main body, data is transmitted between the first and the second CPU via cables; and when the controlling display module is separated from the main body, data is wirelessly transmitted between the first and the second wireless transmission unit.

With these arrangements, the main body can be wirelessly controlled by the separated controlling display module to shoot images, so that the wireless image shooting device of the present invention has increased functionality.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a wireless image shooting device according to a preferred embodiment of the present invention;

FIG. 2 is an assembled view of FIG. 1;

FIG. 3 is a block diagram of the wireless image shooting device according to the preferred embodiment of the present invention;

FIG. 4 shows a first example of using the wireless image shooting device of the present invention; and

FIG. 5 shows a second example of using the wireless image shooting device of the present invention.

### DETAILED DESCRIPTION OF THE PREFERRED EMBODIMENTS

The present invention will now be described with a preferred embodiment thereof and with reference to the accompanying drawings.

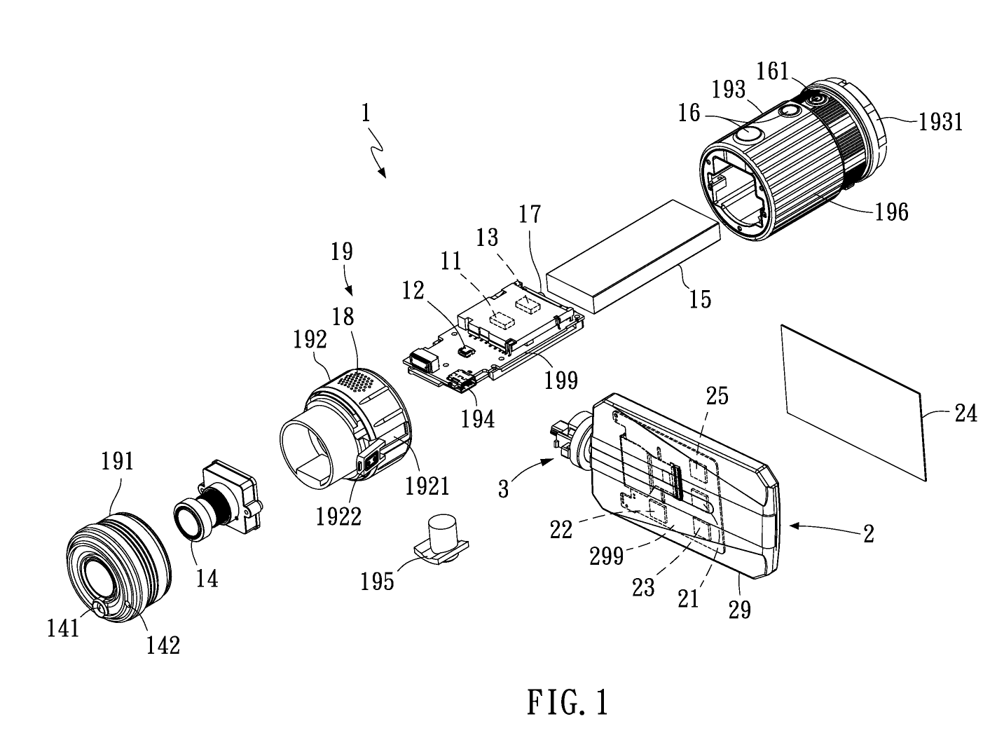

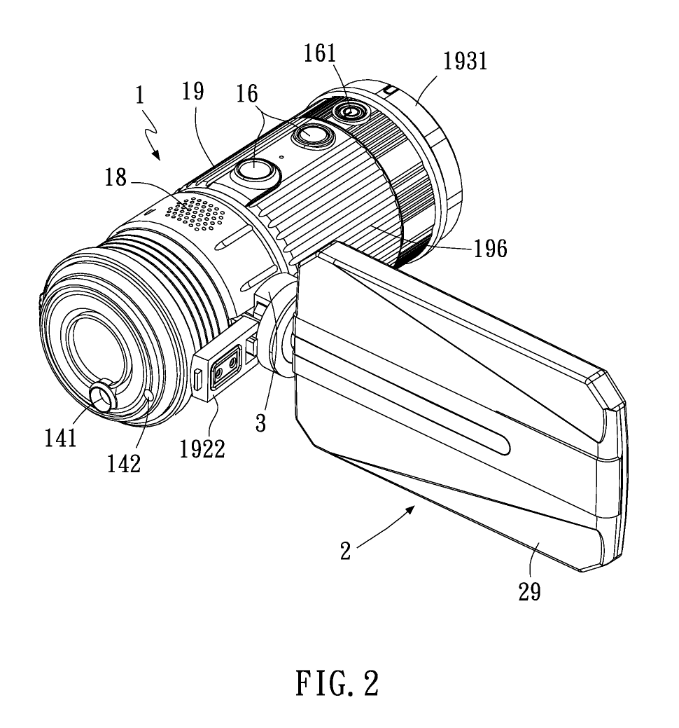

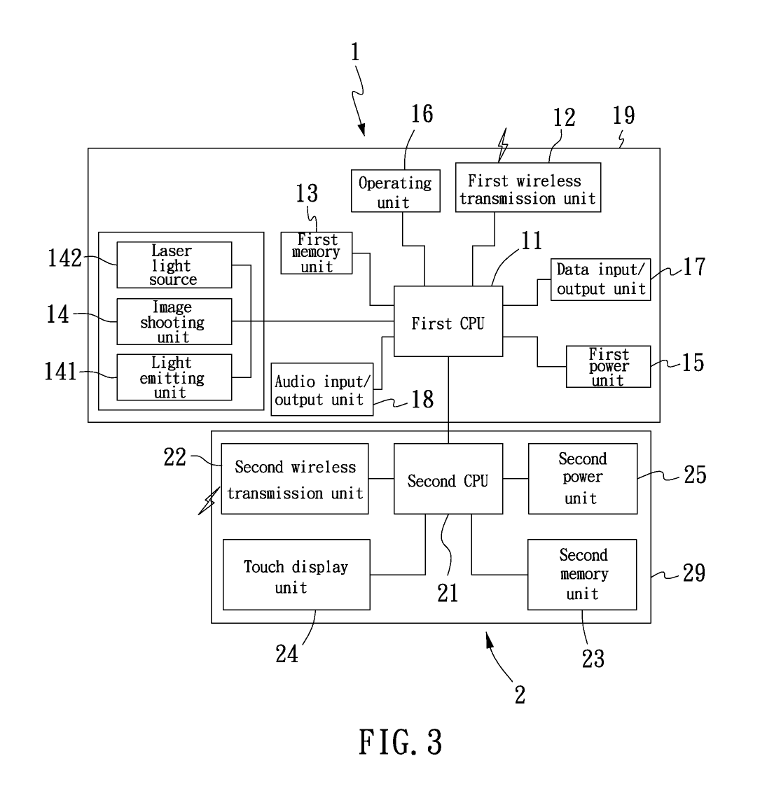

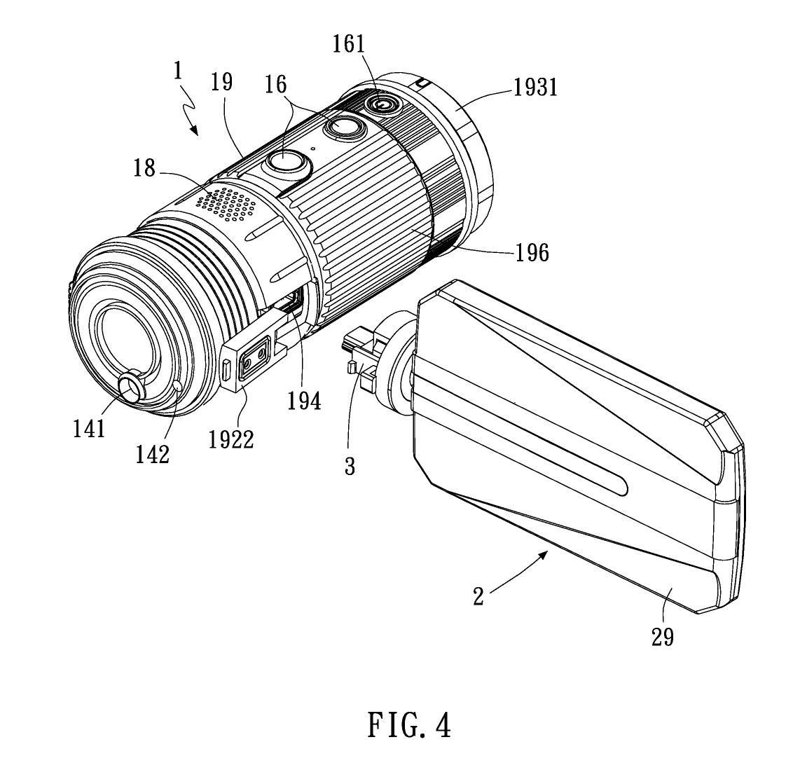

Please refer to FIGS. 1 to 4, wherein FIGS. 1 and 2 are exploded and assembled perspective views, respectively, of a wireless image shooting device according to a preferred embodiment of the present invention, FIG. 3 is a block diagram of the present invention, and FIG. 4 shows a first example of using the wireless image shooting device of the present invention. As shown, the wireless image shooting device of the present invention includes a main body 1 and a controlling display module 2. The main body 1 includes a first central processing unit (CPU) 11, a first wireless transmission unit 12, a first memory unit 13, and an image shooting unit 14. The first wireless transmission unit 12, the first memory unit 13 and the image shooting unit 14 are electrically connected to the first CPU 11. The first CPU 11 may be a microprocessor adapted to receive and process signals transmitted thereto from the first wireless transmission unit 12, the first memory unit 13 and the image shooting unit 14, and to transmit control signals to the first wireless transmission unit 12, the first memory unit 13 and the image shooting unit 14. The first wireless transmission unit 12 may transmit data to an external device via a wireless network, radio waves, Bluetooth technology or the like. The first memory unit 13 may be a random access memory (RAM) or a read-only memory (ROM) for storing data temporarily or permanently, and can be expanded in its data storage capacity by connecting to an external memory device. The image shooting unit 14 may be a CCD (charge-coupled device) sensor or a CMOS (complementary metal-oxide-semiconductor) sensor for shooting moving images or still images. The controlling display module 2 includes a second CPU 21, a second wireless transmission unit 22, a second memory unit 23, and a touch display unit 24. The second wireless transmission unit 22, the second memory unit 23, and the touch display unit 24 are electrically connected to the second CPU 21. The second CPU 21 may be a microprocessor adapted to receive and process signals transmitted thereto from the second wireless transmission unit 22, the second memory unit 23 and the touch display unit 24, and to transmit control signals to the second wireless transmission unit 22, the second memory unit 23 and the touch display unit 24. The second wireless transmission unit 22 may transmit data to an external device via Bluetooth technology, radio waves or the like. The second memory unit 23 may be a random access memory (RAM) or a read-only memory (ROM) for storing data temporarily or permanently, and can be expanded in its data storage capacity by connecting to an external memory device. The touch display unit 24 may be a touch LCD (liquid crystal display) panel capable of synchronously displaying an image shot by the image shooting unit 14 and information about the displayed image. Further, a user may set or control the functions of the main body 1 and of the controlling display module 2 by touching the touch display unit 24.

When the controlling display module 2 is connected to the main body 1, data may be transmitted between the first CPU 11 and the second CPU 21 via cables, so that a user may watch the controlling display module 2 while using the same to control the main body 1 to shoot images. On the other hand, when the controlling display module 2 and the main body 1 are separated from each other, the first wireless transmission unit 12 and the second wireless transmission unit 22 may wirelessly transmit data to each other via Bluetooth technology or radio waves, so that data may be transmitted between the first CPU 11 and the second CPU 21, allowing a user to carry about the controlling display module 2 with him or her and watch the touch display unit 24 at another place distant from the main body 1. The user may also wirelessly control the main body 1 via the controlling display module 2 for the main body 1 to shoot images on site. Therefore, the wireless image shooting device of the present invention provides increased functionality.

The main body 1 further includes a first casing 19, and the controlling display module 2 further includes a second casing 29. The first CPU 11, the first wireless transmission unit 12, the first memory unit 13 and the image shooting unit 14 are fixedly arranged in and protected by the first casing 19. The second CPU 21, the second wireless transmission unit 22, and the second memory unit 23 are fixedly arranged in and protected by the second casing 29. The touch display unit 24 is fitted to an open side of the second casing 29 for closing the latter. The main body 1 and the controlling display module 2 are connected to each other via the first casing 19 and the second casing 29.

The first casing 19 may be cylindrical in shape so as to minimize its volume for easy storage thereof and be more comfortable and convenient for carrying and holding. In addition, the first casing 19 may further include an external rubber layer 196, which can provide the first casing 19 with increased shock-absorbing capacity and suitable frictional contact with the user's hand, so that the wireless image shooting device is protected against unexpected falling and damage during use. Moreover, a water-tight layer (not shown) may be provided between the first casing 19 and the units 11, 12, 13, 14 arranged therein, between the second casing 29 and the units 21, 22, 23, 24 arranged therein, and at a joint between the first casing 19 and the second casing 29, so that the wireless image shooting device of the present invention is water-tight.

The wireless image shooting device of the present invention may further include a movable connector 3. The movable connector 3 has an end movably connected to the controlling display module 2 and electrically connected to the second CPU 21, and has another end extending through the first casing 19 of the main body 1 to detachably insert in a slot 194, which is arranged in the first casing 19 and electrically connected to the first CPU 11. The movable connector 3 is so configured that the controlling display module 2 may be pivotally turned relative to the main body 1 to a folded position, to a desired inclination, or to a desired angular position. When the controlling display module 2 is turned to the folded position, it is restricted from arbitrarily moving relative to the main body 1, making the wireless image shooting device more convenient for use. When the controlling display module 2 is not in use, the user may turn it to the folded position for the same to axially locate at one side of the main body 1, so as to minimize an overall volume of the wireless image shooting device for easy use or carrying thereof. When it is desired to use the controlling display module 2, the user may pivotally turn it outward relative to the main body 1 to a fixed position. In the event a target image is located at a particular angular position, the user may rotate the controlling display module 2 for the same to face the user's eyes, allowing the user to shoot the image conveniently. Further, the movable connector 3 also provides a retaining function, so that the controlling display module 2 is securely and stably connected to the main body 1 without the risk of unexpectedly separating therefrom and falling down to cause damages.

The first casing 19 includes a front case 191, a middle case 192 and a rear case 193 that are sequentially and serially connected to one another. The middle case 192 is provided on a sidewall thereof with an opening 1921 and a cover 1922 movably connected to the opening 1921. When the controlling display module 2 is not connected to the main body 1, the opening 1921 is closed by the cover 1922 to protect the slot 194, which is located behind the opening 1921. On the other hand, to connect the controlling display module 2 to the main body 1, the cover 1922 is opened to expose the opening 1921, and the movable connector 3 may be extended through the opening 1921 to insert in the slot 194.

The main body 1 further includes a light emitting unit 141, a laser unit 142, a first power unit 15, an operating unit 16, a data input/output unit 17 and an audio input/output unit 18, all of which are electrically connected to the first CPU 11, and a first circuit board 199. These units 141, 142, 15, 16, 17, 18 and the first circuit board 199 are arranged in or on the first casing 19. The light emitting unit 141 may be a light-emitting diode (LED) and an infrared light source to help the image shooting unit 14 in shooting image, particularly in the night. With the light emitting unit 141, the wireless image shooting device of the present invention may also serve as a flashlight or electric torch. The laser unit 142 may be directed toward a target to be shot, so as to help the image shooting unit 14 in shooting the image. With the laser unit 142, the wireless image shooting device of the present invention may also serve as a laser pen. The first power unit 15 may be a battery, which may be built in the main body 1 or be positioned in the first casing 19 after a battery cover 1931 is removed from the rear case 193. Alternatively, the first power unit 15 may be an external power supply. The first power unit 15 supplies power to all units and elements of the present invention. The operating unit 16 is provided for a user to operate and control image shooting with the present invention or to set different functions for the present invention. The operating unit 16 may include a power switch 161 for turning on or cutting off the power supplied to the present invention. The data input/output unit 17 serves to input or output data, including image data or setting data, to or from the present invention. The audio input/output unit 18 serves to output sound for a user to listen to and input an audio signal along with the shot image for storing on the first memory unit 13 or the second memory unit 23. On the first circuit board 199, the first CPU 11, the first wireless transmission unit 12, the first memory unit 13, the data input/output unit 17 and the slot 194 are arranged.

The controlling display module 2 further includes a second power unit 25 and a second circuit board 299, which are arranged in the second casing 29. The second power unit 25 is electrically connected to the second CPU 21 and may be a battery, which may be built in the controlling display module 2 or be positioned in the second casing 29 after opening the second casing 29. The second power unit 25 supplies power to all units and elements in the controlling display module 2, or even supplies power to all units and elements of the present invention. On the second circuit board 299, the second CPU 21, the second wireless transmission unit 22, the second memory unit 23, and the second power unit 25 are arranged.

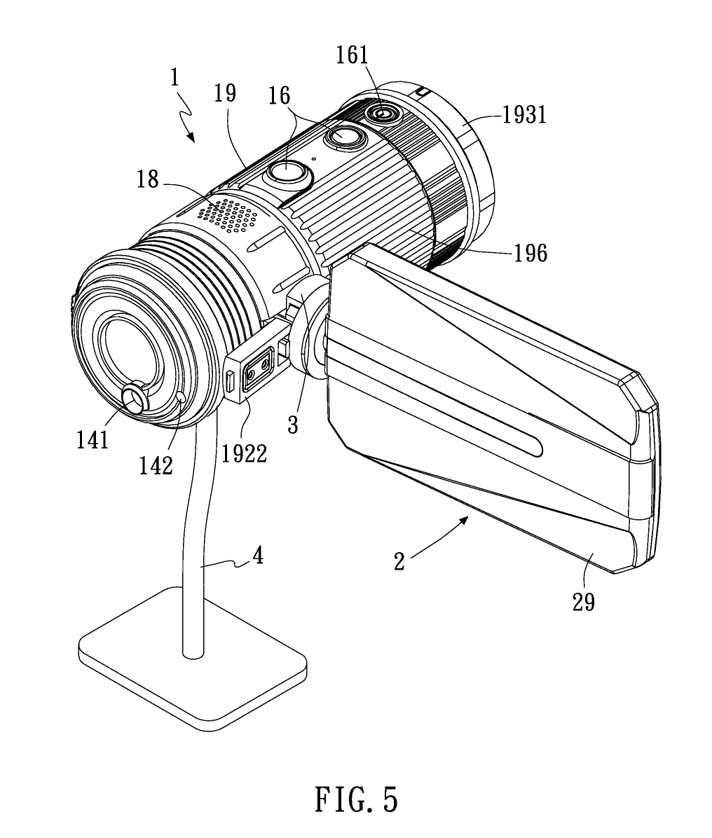

FIG. 5 shows a second example of using the wireless image shooting device of the present invention. Please refer to FIGS. 1 and 5 at the same time. As shown, the first casing 19 further includes a holding unit 195, which is internally provided with screw threads for meshing with external screw threads on a mount 4. By connecting the main body 1 to the mount 4 via the holding unit 195, the wireless image shooting device of the present invention may be fixed to any place to enable stable and convenient image shooting. Therefore, in addition to be used as a camera or a camcorder, the present invention is also suitable for use in other places that require image shooting, such as being used in a car as an event data recorder and the like.

With the above arrangements, the present invention is novel, improved, and industrially valuable. The present invention is novel and improved because the controlling display module and the main body of the wireless image shooting device may wirelessly transmit data to each other via the first and the second wireless transmission unit, so that the controlling display module can wirelessly control the main body to shoot images, which enables the present invention to have increased functionality. The present invention is industrially valuable because products derived from the present invention would no doubt fulfill the current market demands.

The present invention has been described with a preferred embodiment thereof and it is understood that many changes and modification in the described embodiment can be carried out without departing from the scope and the spirit of the invention that is intended to be limited only by the appended claims.

What is claimed is:

1. A wireless image shooting device, comprising:
a main body including a first central processing unit (CPU), a first wireless transmission unit, a first memory unit, and an image shooting unit; and the first wireless transmission unit, the first memory unit and the image shooting unit being electrically connected to the first CPU; and
a controlling display module including a second CPU, a second wireless transmission unit, a second memory unit, and a touch display unit; the second wireless transmission unit, the second memory unit and the touch display unit being electrically connected to the second CPU;
wherein when the controlling display module is connected to the main body, data is transmitted between the first and the second CPU via cables; and when the controlling display module is separated from the main body, data is wirelessly transmitted between the first and the second wireless transmission unit.

2. The wireless image shooting device as claimed in claim 1, wherein the main body further includes a first casing, and the controlling display module further includes a second casing; the first CPU, the first wireless transmission unit, the first memory unit and the image shooting unit being arranged in the first casing; and the second CPU, the second wireless transmission unit, the second memory unit and the touch display unit being arranged in the second casing; and wherein the main body and the controlling display module are connected to each other via the first casing and the second casing.

3. The wireless image shooting device as claimed in claim 2, wherein the first casing is cylindrical in shape.
